(19) United States
(12) Patent Application Publication
(10) Pub. No.: US 2012/0158393 A1
(43) Pub. Date: Jun. 21, 2012

(54) METHOD FOR PLACING THERMOELECTRIC GENERATORS IN TECHNICAL INSTALLATIONS

(76) Inventors: Birthe Böhm, Nurnberg (DE); Matthias Dürr, Nurnberg (DE); Thilo Tetzner, Nurnberg (DE)

(21) Appl. No.: 13/392,926

(22) PCT Filed: Aug. 17, 2010
(86) PCT No.: PCT/EP2010/061974

§ 371 Date: Feb. 28, 2012

(30) Foreign Application Priority Data
Aug. 31, 2009 (EP) 09011178.2
Nov. 11, 2009 (EP) 09014125.0

(51) Int. Cl. G06F 17/50

(52) U.S. Cl. 703/18

(57) ABSTRACT

A method and system for placing thermoelectric generators in technical installations, wherein an installation model is created from interacting mechatronic objects, comprising type-specific and installation-specific thermodynamic prior and subsequent conditions, and a respective thermal energy difference between the mechatronic objects is taken as a basis for determining possible locations of use for thermoelectric generators in the installation.

### CROSS-REFERENCE TO RELATED APPLICATIONS

This application is a U.S. National Stage Application of International Application No. PCT/EP2010/061974 filed Aug. 17, 2010, which designates the United States of America, and claims priority to EP Patent Application No. 09011178.2 filed Aug. 31, 2009 and EP Patent Application No. 09014125.0 filed Nov. 11, 2009. The contents of which are hereby incorporated by reference in their entirety.

### TECHNICAL FIELD

The present disclosure relates to a method and an engineering system for placing thermoelectric generators in technical installations. The disclosure also relates to a computer program product and a computer-readable medium for carrying out the method.

BACKGROUND

In some conventional thermoelectric generators, use is made of the fact that, in the case of temperature gradients between two electric conductors, an electric voltage develops which can be used for energy production.

Thermoelectric generators have been used for a relatively long time in aerospace and metrology and, more recently, also experimentally in automotive engineering.

In the automation of manufacturing (for example production plants or assembly lines) or processing installations (for example refineries or breweries), the energy supply for the used control devices (for example stored programmable control systems, automation systems) or field devices (for example actuators, sensors) is often an important aspect in addition to the communication connection between these devices and typically should be considered within the scope of installation engineering. With regard to the energy supply of such installations, fail-safe operation, electrical safety, the grouping of cable lines, the necessary insulation and legal provisions may need to be observed inter alia.

Owing to these high demands in terms of the electrical energy supply, a conventional energy supply, for example by an external energy supplier and in-house emergency power units, is often used in technical installations.

### SUMMARY

In one embodiment, a method for placing thermoelectric generators in technical installations is provided. The method may include (a) reproducing the technical installation as an installation model consisting of interacting mechatronic objects within the scope of installation engineering, wherein a mechatronic object contains type-specific thermodynamic prior and subsequent conditions; (b) supplementing the mechatronic objects with installation-specific thermodynamic conditions; (c) determining energy chains from installation engineering, wherein the energy chains consist of mechatronic objects connected in series; (d) determining the energy balance for each mechatronic object of the energy chain; and (e) examining the energy balance of the mechatronic objects of an energy chain upon fulfillment of necessary thermodynamic conditions for the use of thermoelectric generators.

In a further embodiment, the method further includes automatically presenting locations for use with sufficient energy potential for thermoelectric generators in the installation model by suitable output means. In a further embodiment, the method further includes modeling the thermoelectric generator as a mechatronic object and integrating this mechatronic object in the installation model. In a further embodiment, when automatically presenting the locations for use of thermoelectric generators, the following conditions are considered: fail-safe operation of the energy source used and/or material incompatibility and/or installation topology and/or spatial conditions and/or temporal behaviour and/or standards and/or guidelines and/or maintainability and/or physical properties of the thermoelectric generator. In a further embodiment, the method further includes: calculating the energy available in the energy producer chain for the thermoelectric generator modeled as a mechatronic object; and dedicated feeding of energy into the energy producer chain by energy sources modeled in the installation model if the energy available for the thermoelectric generator modeled as a mechatronic object is insufficient.

In another embodiment, a method for the localisation of thermoelectric generators in technical installations includes: (a) reproducing the technical installation as an installation model, consisting of interacting mechatronic objects, within the scope of installation engineering, wherein a mechatronic object contains type-specific thermodynamic prior and subsequent conditions; (b) supplementing the mechatronic objects with installation-specific thermodynamic conditions; (c) determining the respective thermal difference requirement for the mechatronic objects; (d) determining energy chains in the installation model; (e) modeling a thermoelectric generator as a mechatronic object, wherein the thermal difference requirement of the thermoelectric generator is deposited in the mechatronic object; (f) integrating the thermoelectric generator modeled as a mechatronic object in an energy chain of the installation model; (g) calculating the energy available in the energy chain for the thermoelectric generator modeled as a mechatronic object; and (h) dedicated feeding of energy into the energy chain by energy sources modeled in the installation model if the energy available for the thermoelectric generator modeled as a mechatronic object is insufficient.

In a further embodiment, when integrating the thermoelectric generator modeled as a mechatronic object in the installation model, the following conditions are considered: fail-safe operation of the energy source used and/or material incompatibility and/or installation topology and/or spatial conditions and/or temporal behaviour and/or standards and/or guidelines and/or maintainability and/or physical properties of the thermoelectric generator. In a further embodiment, a mechatronic object represents a technical component of a technical installation and contains facets, wherein a discipline is assigned to a facet. In a further embodiment, the following disciplines can be assigned: mechanics and/or electrics and/or automation and/or distribution and/or calculation and/or project management and/or maintenance and/or safety and/or system management and/or civil engineering and/or engineering.

In another embodiment, a computer program product is provided for placing thermoelectric generators in technical installations is provided. The computer program, when executed, is configured to perform or facilitate the following steps: (a) reproducing the technical installation as an installation model consisting of interacting mechatronic objects within the scope of installation engineering, wherein a mechatronic object contains type-specific thermodynamic prior and subsequent conditions; (b) supplementing the mechatronic objects with installation-specific thermodynamic conditions; (c) determining energy chains from installation engineering, wherein the energy chains consist of mechatronic objects connected in series; (d) determining the energy balance for each mechatronic object of the energy chain; and (e) examining the energy balance of the mechatronic objects of an energy chain upon fulfillment of necessary thermodynamic conditions for the use of thermoelectric generators

In another embodiment, a computer-readable medium contains instructions which, when run on a suitable computer, prompt the computer to implement any or all of the steps or functions discussed above.

In another embodiment, an engineering system for the modeling of technical installations is provided for carrying out a method including any or all of the steps or functions discussed above.

### BRIEF DESCRIPTION OF THE DRAWINGS

Example embodiments will be explained in more detail below with reference to figures, in which:

In the drawings:

FIG. 1 is an exemplary schematic view of a technical installation, according to an example embodiment;

FIG. 2 is an abstract overview of a mechatronic object, according to an example embodiment;

FIG. 3a is an exemplary tree of mechatronic objects, according to an example embodiment;

FIG. 3b is a schematic view of a mechatronic object with facets, according to an example embodiment;

FIG. 4 shows an example of an object-oriented representation of mechatronic objects in UML notation, according to an example embodiment; and

FIG. 5 shows an exemplary device for carrying out the method according to the invention.

### DETAILED DESCRIPTION

Some embodiments provide an efficient and reliable method for the placing and use of thermoelectric generators in technical installations.

Some embodiments provide a method comprising the following steps: (a) reproducing the technical installation as an installation model consisting of interacting mechatronic objects within the scope of installation engineering, wherein a mechatronic object contains type-specific thermodynamic prior and subsequent conditions; (b) supplementing the mechatronic objects with installation-specific thermodynamic conditions; (c) determining energy chains from installation engineering, wherein the energy chains consist of mechatronic objects connected in series; (d) determining the energy balance for each mechatronic object of the energy chain; and (e) examining the energy balance of the mechatronic objects of an energy chain upon fulfillment of necessary thermodynamic conditions for the use of thermoelectric generators. A comprehensive use of thermoelectric generators was not previously possible in industrial installations owing to the associated high cost for modeling (for example owing to the complexity of the parameters to be considered) and owing to restrictions of use (for example sufficient availability of an energy source and validation of the availability). The present engineering principle is based on the concept of “mechatronic objects”, which are used for the modeling of the use and distribution of thermoelectric generators in industrial installations. Mechatronic objects make it possible to provide some, many, or even all essential aspects of an installation in integrated form, even in the early phases of project development of an installation. There is thus an opportunity to efficiently counteract the complexity of the use of thermoelectric generators in industrial applications.

In one embodiment, the method further comprises automatically presenting locations for use with sufficient energy potential for thermoelectric generators in the installation model by suitable output means. As a result of the automatic presentation (for example by colour coding) of possible locations for use of thermoelectric generators in an installation plan (for example on an output device (for example printer, screen)) of an engineering system, the points of an installation at which, in principle, a thermoelectric generator can be used may be indicated to a user.

In one embodiment, the method further comprises modeling the thermoelectric generator as a mechatronic object and integrating this mechatronic object in the installation model. The design of thermoelectric generators as mechatronic objects and their integration in the installation model, consisting of mechatronic objects, may ensure that there is no method and media break in installation engineering.

In one embodiment, when automatically presenting the locations for use of thermoelectric generators, the following conditions are considered: the fail-safe operation of the energy source used and/or material incompatibility and/or installation topology and/or spatial conditions and/or temporal behaviour and/or standards and/or guidelines and/or maintainability and/or physical properties of the thermoelectric generator. As a result of the consideration of these conditions, economic criteria may also be incorporated when determining the locations for use of thermoelectric generators. The list of conditions is not conclusive, and further possible conditions may also be defined.

In one embodiment, the method also comprises:
calculating the energy available in the energy producer chain for the thermoelectric generator modeled as a mechatronic object; and dedicated feeding of energy into the energy producer chain by energy sources modeled in the installation model if the energy available for the thermoelectric generator modeled as a mechatronic object is insufficient. If no, or insufficient thermal energy is available for thermoelectric generators which have already been scheduled or placed, these installation locations can be made useful for thermoelectric generators by feeding additional energy into the installation process and by providing this energy at specific installation locations. An installation can thus be revised in a simple and targeted manner for the use of thermoelectric generators.

Some embodiments provide a method for the localisation of thermoelectric generators in technical installations, comprising the following steps: (a) reproducing the technical installation as an installation model, consisting of interacting mechatronic objects, within the scope of installation engineering, wherein
a mechatronic object contains type-specific thermodynamic prior and subsequent conditions;

(b) supplementing the mechatronic objects with installation-specific thermodynamic conditions;

(c) determining the respective thermal difference requirement for the mechatronic objects;

(d) determining energy chains in the installation model;

(e) modeling a thermoelectric generator as a mechatronic object, wherein the thermal difference requirement of the thermoelectric generator is deposited in the mechatronic object;

(f) integrating the thermoelectric generator modeled as a mechatronic object in an energy chain of the installation model;

(g) calculating the energy available in the energy chain for the thermoelectric generator modeled as a mechatronic object; and

(h) dedicated feeding of energy into the energy chain by energy sources modeled in the installation model if the energy available for the thermoelectric generator modeled as a mechatronic object is insufficient. If no, or insufficient thermal energy is available for thermoelectric generators which have already been scheduled or placed, additional energy can be fed into the installation process by changing installation parameters so as to utilise this energy for thermoelectric generators at suitable points in the installation. An installation can thus be revised in a simple manner for the use of thermoelectric generators.

In a further embodiment, when integrating the thermoelectric generator modeled as a mechatronic object in the installation model, the following conditions are considered: fail-safe operation of the energy source used and/or material incompatibility and/or installation topology and/or spatial conditions and/or temporal behaviour and/or standards and/or guidelines and/or maintainability and/or physical properties of the thermoelectric generator. As a result, economic and safety-relevant criteria are also considered in the integration of thermoelectric generators in the installation model. The procedure when determining suitable locations in industrial installations for the use of thermoelectric generators can thus be carried out in a scaled or stepwise manner. Firstly, locations may be determined at which the energy balance for the use of thermoelectric generators is sufficient in principle (necessary conditions), then further requirements and conditions are examined (sufficient conditions). This stepwise procedure may increase the efficiency of the method and may prevents wrong decisions during the placing of thermoelectric generators, even in the early phases of installation engineering. This list of conditions is not conclusive. It is also possible for further conditions to be defined.

In some embodiments, a mechatronic object represents a technical component of a technical installation and contains facets, wherein a discipline is assigned to a facet. The term “mechatronics” describes the interaction between different disciplines, such as mechanics, electrics and automation depending on the industry and requirement, as well as further information on activities which assist the engineering or project development in different ways (for example: distribution, calculation, project management, etc.). This mechatronic information may be based on the technical components used. This interaction is described by a digital representation of the object, that is to say the “mechatronic object” (MO). An MO may contain different “facets”, for example a facet for each discipline. The facets illustrate the data of a respective discipline. Software principles, such as the locality principle and data encapsulation are thus considered in a simple manner.

In some embodiments, the following disciplines can be assigned: mechanics and/or electrics and/or automation and/or distribution and/or calculation and/or project management and/or maintenance and/or safety and/or system management and/or civil engineering and/or engineering. As already mentioned, mechatronic objects describe the interaction between various disciplines which assist installation engineering or project development. As a result of the concentration of respective relevant aspects (for example data, perspectives, methods, attributes, documentation) of these disciplines in the corresponding mechatronic objects, this information is not distributed to any points of an installation, but are provided where they belong logically. This facilitates, for example, the increase or assurance of installation consistency. The list of possible disciplines is not conclusive. Further disciplines may also be assigned depending on domain and field of use.

Some embodiments provide an engineering system for the modeling of technical installations, which system is suitable for carrying out one of the methods according to the present disclosure. The engineering system may be a commercially available computer (for example a PC or workstation) with corresponding software with modeling tools (for example UML work environment) for carrying out the method. Depending on the requirements and work environment, a correspondingly equipped industrial PC may also be used as a computer.

Some embodiments provide a computer program product or a computer-readable medium which prompts the execution of the method on a program-controlled device. This may facilitates the versatility of use and also the spread and commercial distribution of the method according to the present disclosure.

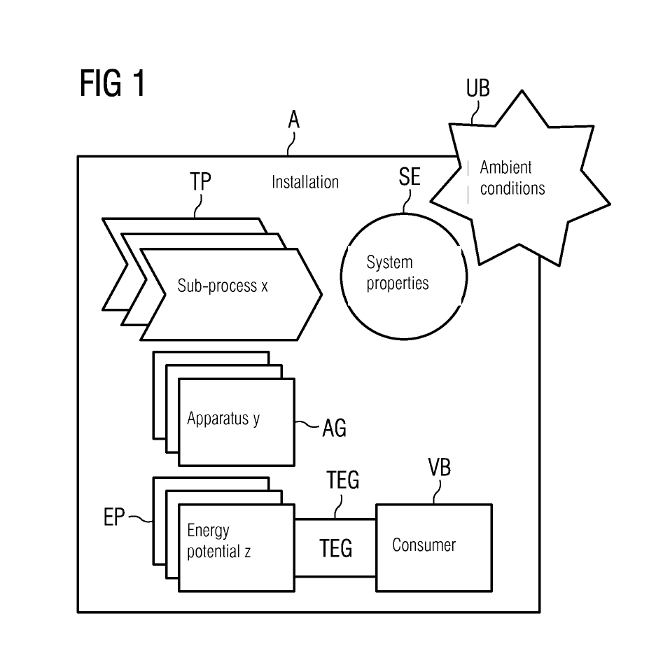

FIG. 1 shows an exemplary schematic view of a technical installation A with mechanical and electrical components AG (apparatuses) for carrying out sub-processes TP, such as feeding, assembling, measuring, and mixing, according to an example embodiment. Thermoelectric generators TEG use differences in the energy potential EP (for example different temperature or heat potentials) of consumers VB for energy production. During energy production by thermoelectric generators TEG in technical installations (for example production plants, process engineering systems), the system properties SE and the ambient conditions UB of an installation

A are to be considered in addition to the potential difference of upstream and downstream consumers. System properties SE include, inter alia, the installation topology and reliability and safety requirements. Ambient conditions include, inter alia, the location or infrastructure of the location, but also ambient temperature or the heat potential of the surrounding environment.

A multiplicity of electronic components AG are used in the automation of industrial installations A and have to be supplied reliably with electrical energy in changing ambient UB and operating conditions SE.

Different approaches are currently being adopted by means of new or improved physical methods to produce electrical energy from energy potential differences EO, which were previously useless from an economic point of view, and, in particular, to this this energy for the purposes of utilising decentral and/or wireless signal processing. In addition to the ecological aspect (energy harvesting), there is also the aspect of efficient design of technical systems, in which the focus lies on the simplification of the systems by the elimination of entire sub-systems (for example for wired power supply).

A fundamental problem is that the correlation between availability of energy potential and consumer need is generally poor, that is to say energy is provided when it is not needed or energy is needed when there is no potential. An established approach is the use of energy stores, for example an accumulator in a passenger car (battery). This approach has limits, however: for example a car battery is quickly run down in city traffic with many start-up processes. Furthermore, energy stores often exhibit poor efficiency and are subject to aging. In particular with development in the field of energy harvesting, it is attempted to overcome this problem by energy management. In practice, this amounts to considerable compromises in terms of usability (low throughput, sporadic or unpredictable availability). These compromises constitute considerable limitations with regard to usability and reliability compared to the grid-connected devices used today.

In addition to this central problem, there are a series of further questions which result from the complexity of typical industrial installations A. The conventional “discrete” engineering process for the use of thermoelectric generators TEG in industrial installations A is typically oriented towards a prioritised sequence of detailed questions, for example the search for a sufficient heat potential difference, the estimated temporal availability thereof, the search for a fixing option with suitable cable lengths, suitable assembly (attainability, geometry, material pairing, heat conducting paste, etc.), and so on. A considerable number of these decisions have to be made based on estimations, since relevant information is not available or is only available in unsuitable form, or since it is only possible to establish this information at high cost.

To summarise, it can be noted that:

The use of thermoelectric generators for the purposes of industrial automation was previously largely based on estimations (or the “hope principle”) with regard to the availability of the energy supply and the incorporation in the overall installation. Owing to the existing uncertainty, the use of thermoelectric generators is often ruled out in principle, in particular in critical installations, and a conventional energy supply is instead selected. For engineering and the use of thermoelectric generators TEG, current solutions typically cannot be incorporated efficiently and reliably in the overall model of an industrial installation. Current solutions are individual solutions, with little opportunity for reuse and with the resultant potential.

In principle, the following solutions were previously selected for the use of thermoelectric generators TEG in technical installations A:
Limitation to uses with low availability requirements.
Complex modeling of the use and detailed provision of additional information (operating plans, etc.).

A comprehensive use of thermoelectric generators was not previously to be expected in industrial installations owing to the associated high cost of modeling and the extreme limitation of use and the associated necessary risk assessment. Conventional energy supply solutions were previously generally preferred in industrial installations to establish, in return, simple planning of the industrial installation and an overall solution based on previous experience. This is not optimal in the course of a lifecycle-cost consideration.

To solve the problem of use and distribution of thermoelectric generators in installations A, it is important to know that a subsequent or additional integration “ex post” is not generally expedient owing to the complexity of the relationships and the implementation cost, and at best only functions reliably in special cases. In principle this is also possible within the scope of modernisation of the installation, however.

Embodiments of the present invention proceed from the idea of utilising innovative engineering concepts, such as the concept of mechatronic objects, e.g., to solve the problem of distribution of thermoelectric generators in industrial installations A. Mechatronic objects allow the provision of some, many, or even all key aspects of an installation in integrated form, even in the early phases of project development of an installation A. There is thus an opportunity to efficiently counteract the complexity of the use of thermoelectric generators in industrial applications.

The problem may be solved by the design of thermoelectric generators TEG as mechatronic objects within the scope of a mechatronic engineering system.

Embodiments of the invention may be based on the mechatronic concept, which is based substantially on the integration of different disciplines or trades. Consequently, a highly improved quality of the solution and reduced engineering times and costs may be provided by a close integration of the information from different disciplines to form an object.

The term and concept of mechatronics describes the interaction between different disciplines, such as mechanics, electrics and automation depending on the industry and requirement, as well as further information on activities which assist the engineering or project development in different ways (for example: distribution, calculation, project management, etc.).

This mechatronic information may be based on the technical components used. This interaction is described by a digital representation of the object, that is to say the “mechatronic object” (MO). An MO may contain different “facets”, for example a facet for each discipline. The facets contain the data of a discipline, whereas the MO structure aggregates and links this data.

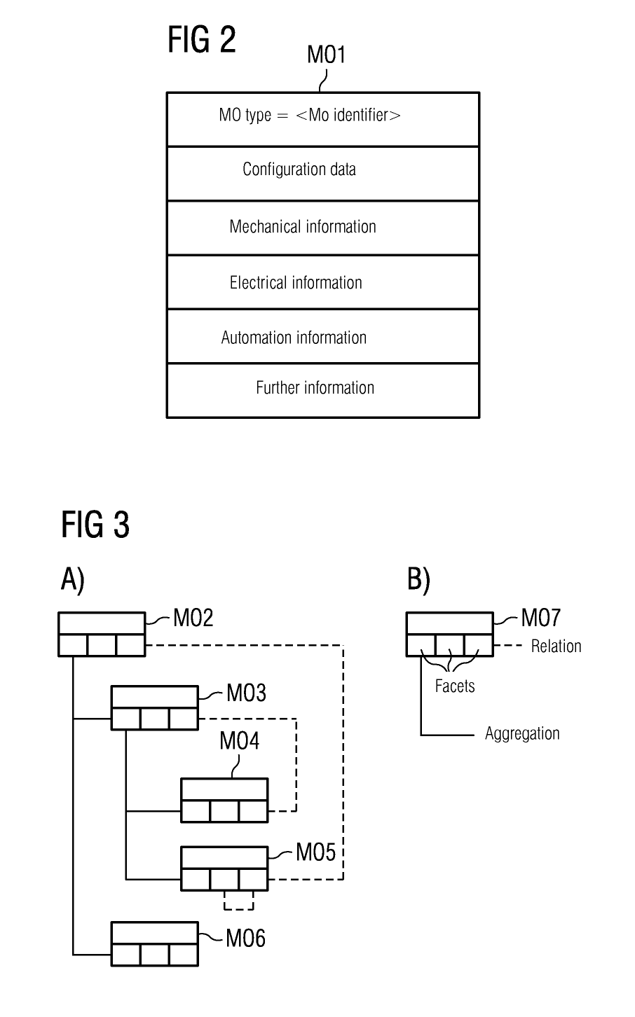

FIG. 2 shows an abstract overview of a mechatronic object MO1, according to an example embodiment. A mechatronic object MO1 preferably represents a component of the real world, for example of a technical domain. In the field of process engineering, this may be pumps, containers, valves, pipes, heating elements or stirrers for example. In the context of industrial control systems, this may be components of machine tools or production machines for example. The mechatronic objects MO1 provide a defined technical, self-contained function. They can be interconnected so as to carry out complex technical tasks. Furthermore, a mechatronic object MO1 may be used again, as a software unit, in different applications in a very simple manner by a user. A user can abstract from the implementation of mechatronic objects MO1 during use thereof. Mechatronic objects MO1 which can be used directly by the user in his application software are created by their instantiation from object types. Any number of instances of mechatronic objects can be produced from an object type defined once.

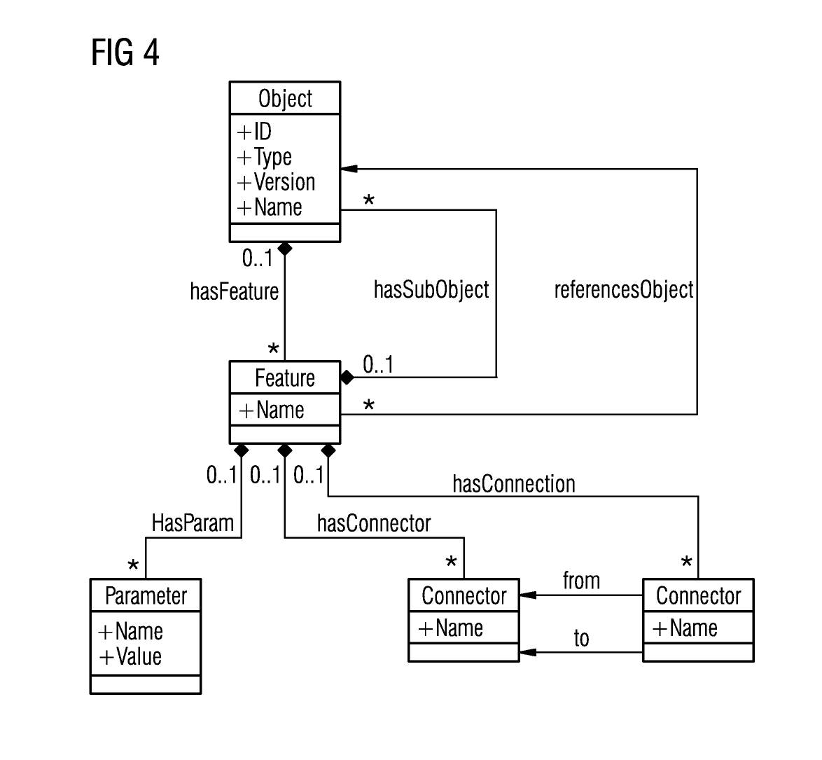

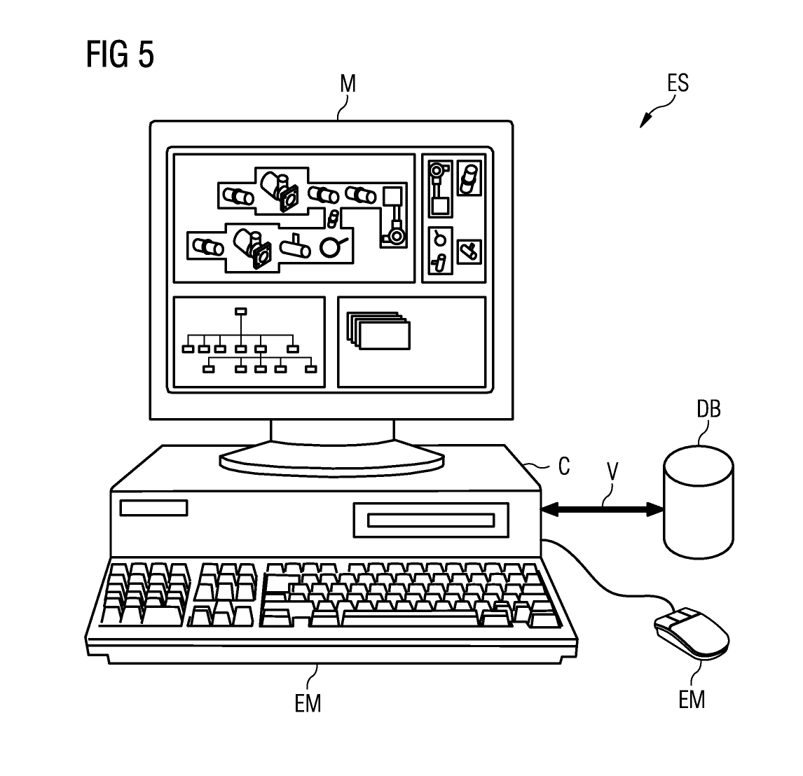

The illustration according to FIG. 4 shows an exemplary schematic view of the user's view of a mechatronic object MO1, that is to say an instance of an object type, according to an example embodiment. The uppermost part (object), separated from the following parts by a continuous line, contains the type of underlying mechatronic object (MO type) and the MO identifier, that is to say the identifier of instantiation unique to the project or installation.

The next part contains configuration data. The mechatronic object MO1 is set in terms of its basic function by the configuration data. The mechatronic object MO1 is parameterised by the configuration data. In the illustration according to FIG. 2, the configuration data is separated from the mechanical information (for example HW, devices) by a line.

The next section is the electrical information (electricity, power supply, etc.).

The next section in FIG. 2 for a mechatronic object MO1 is the automation information (for example program for a stored programmable control system). Further information for a mechatronic object may be alarms, system variables, or information regarding distribution, calculation, project management, maintenance or documentation.

FIG. 3a shows an exemplary tree of mechatronic objects MO2 to MO6, according to an example embodiment. A mechatronic object MO2 to MO6 describes an element in engineering, such as a device or machine. If a device or machine is integrated for example in a sub-system or production line, the assigned mechatronic objects MO3 to MO6 may then also be aggregated in a superordinate mechatronic object MO2 for the sub-system or production line. In some embodiments, this concept may require defined interfaces of the mechatronic objects MO2 to MO6, via which they can be interlinked for the encapsulation of information. The continuous lines in FIG. 3a represent an aggregation relation between the mechatronic objects MO2 to MO6. The dashed line indicates that further relations can be produced between the mechatronic objects MO2 to MO6, such as functional aspects, constructional aspects and safety aspects (safety and security). The rectangles in the mechatronic objects MO2 to MO6 indicate that a mechatronic object may contain facets.

FIG. 3b shows a schematic view of a mechatronic object MO7 with facets. A mechatronic object MO7 describes an element in engineering, for example a device or a machine. If a device or a machine is integrated in a sub-system or production line for example, the assigned mechatronic objects may then also be aggregated in a superordinate mechatronic object for the sub-system or production line (see MO2 in FIG. 3a). In some embodiments, this concept may require defined interfaces of the mechatronic objects MO7, via which the mechatronic objects can be interlinked for the encapsulation of information.

The data deposited in a mechatronic object MO7 may thus contain information regarding the general thermodynamic properties of a mechatronic object, such as, for a “container” mechatronic object, the minimum and maximum temperature of liquids which may be fed into the container as well as further information such as flow rate, pressure, etc. This general thermodynamic information is supplemented with further data in a manner specific to an installation: for example the actual temperature of the liquid which is fed into the container and the temperature of the liquid after “processing” in the container are also relevant. Generally, the thermodynamic prior and subsequent conditions of a mechatronic object are relevant for energy harvesting, but also play a role in the “conventional” planning of an industrial installation since they may be required for the design of the installation.

Based on the thermodynamic data of a mechatronic object MO7, a corresponding engineering system will calculate thermal energy available for a thermoelectric generator (TEG; FIG. 1) from the MO structure (for example the installation model, based on mechatronic objects), which represents the installation completely or in part: if the heat requirement of a mechatronic object is lower than the available heat flow of the mechatronic objects directly upstream in the MO structure, the difference allows the use of a thermoelectric generator. This difference is indicated by the engineering system as usable energy and provides the design engineer with information as to where the use of thermoelectric generators (TEG; FIG. 1) is possible based on energy potentials. The method according to some embodiments considers energy sources (from the process) when selecting locations for the placement of thermoelectric generators in an installation, but also energy sinks (for example the surrounding environment, which can also be regarded and modeled primarily as a mechatronic object). If, for example, the temperature of the surrounding environment is as high as the temperature of the heat source/sink to be tapped (point of the installation process), a thermoelectric generator cannot sensibly be installed at this point.

The design engineer may then be provided with a presentation in which, for example, areas of the installation in which a thermoelectric generator can be used with the desired properties are marked and displayed visually in the planning data as “green areas” or “green clouds” (for example on a monitor or in a printout), and those areas with restrictions are marked as yellow, etc.

The design engineer can make a decision based on these proposed locations of use of the required thermoelectric generators and can place a mechatronic object directly in the mechatronic engineering system, which mechatronic object acts as a representative object for the thermoelectric generator and contains the data of the thermoelectric generator (for example in the facets). The calculated data regarding the suitability of the different locations of use are presented to the design engineer by the engineering system so that, for example, he can also make a decision on the basis of the reliability of the energy source.

Alternatively, the information of this TEG-MO (mechatronic object which represents a thermoelectric generator) can be used for a further localisation of the use of the thermoelectric generator. It is either possible for mechatronic objects MO7 which have already been instantiated but not yet placed to be produced in the engineering system by the design engineer, in which mechatronic objects the consumer MO may already be defined but the associated energy producer MO still has to be assigned, or searches for locations for use for selected TEG types or for all TEG types provided in the engineering system can be carried out in an inclusive manner (see above). One MO type is necessary for each type of thermoelectric generator if the thermoelectric generator differs owing to its possibilities for use (and data). Prerequisites for the use of the thermoelectric generator are contained in the mechatronic object or MO type. For example, this may be the required power as well as material properties, geometry (incl. connections) of the thermoelectric generator, etc. (see below).

For complete planning of an overall solution with thermoelectric generators, a TEG type is instantiated in an installation project and is assigned directly as a function to one or more energy consumer MO. Further information regarding the requirements of a thermoelectric generator emerges from the assignment to an energy consumer MO: for example specifications of the energy consumer MOs for fail-safe operation of the energy source, on the basis of which the availability of the thermoelectric generator has to be determined.

Once possible locations for installation have been identified on the basis of the available energy—as described above—additional information regarding used material, geometry of the mechanical construction, temporal behaviour of the heat flow, spatial conditions, applicable standards and guidelines, maintainability of the solution, etc. may be modeled by the TEG-MO (thermoelectric generator modeled as a mechatronic object) and energy producer MOs may be used to determine more precisely therefrom the actual possibilities for assembly in the planned installation

Examples of this include:
Material incompatibility: the material of a pipeline may be unsuitable for the connection of a TEG, since the two materials of the pipeline and of the TEG connection are not compatible (for example owning to corrosion). In this case, a thermoelectric generator (TEG) cannot be connected or a connecting piece may possibly be provided, for which sufficient space in the surrounding environment must be present. A heat conducting paste may have to be used, which may influence service, etc.
Geometry: Is the connection of a TEG geometrically possible? That is to say, with regard to sizing, shape and pipe curvature, etc.?
Spatial conditions: The additional spatial requirement of the TEG may not be met when considering the installation as a whole. Incorporation is therefore not possible with regard to a specific MO. Or, it may only be possible to incorporate a TEG at a very far distance from the place of use of the electrical energy generated (if known)—savings with regard to wiring can therefore not be made, and instead the cable routing is considerably more complex and can only be implemented with difficulty.
Temporal behaviour: How reliably are the given thermodynamic properties achieved? This may emerge, for example, from the provided schedules of the installation, or, conversely, the reliability required by the TEG or necessary temporal behaviour may emerge from the location for use of the TEG (thermoelectric generator) or from an overall strategy for the installation. These conditions may either be predefined centrally in the engineering system or it is initially assumed on the whole that a greater availability also means greater suitability, and the ultimate decision is left to the design engineer.
Standards and guidelines: The specification of certain standards and guidelines (for example FDA) may rule out the use of a TEG for safety reasons (either completely or in sub-areas of the installation).
Maintainability: Is the maintainability of the TEG ensured? For example, if the TEG had to be maintained at regular intervals, the question must be asked as to whether this might only be possible at very high cost based on the spatial conditions.
Further restrictions are possible, for example, owing to further physical properties of the TEG: Can a TEG be installed at the desired location based on the weight of the TEG and the load-bearing capacity of the energy producer (for example pipe or container):

The engineering system may include these restrictions in the calculations and thus already automatically rule out some of the locations for installation of a TEG which initially appeared to be suitable. The extent to which these criteria are already automatically considered depends on the design of the engineering system.

FIG. 4 shows an example of an object-oriented representation of mechatronic objects in UML notation, according to an example embodiment. In principle, any object-oriented notation can be used. Mechatronic objects may be designed and implemented by a user with the aid of engineering systems or software development conditions which support object-oriented paradigms (classes, types, inheritance, etc.). The rectangles in FIG. 4 represent the involved objects or partial objects, and the lines with the corresponding notation represent the relationships between the objects (“has”, “from”, “is a”, etc.).

In a software development environment, mechatronic objects may be implemented for example in an object-oriented programming language (for example C++), and a basic “MO” class may first be defined which implements the basic concepts of the mechatronic objects and provides a standardised interface. Such a class may define generic facets and standard facets for example, and may contain generic methods for access to any facets. Further classes may then be derived from this base class for any type of technical component of a technical installation and supplemented by further facets, and information may be added. A “TEG” class may first be defined for TEGs which includes the general properties and facets of all TEGs. For a specific TEG type x, a class “TEG_x” is then derived from the class “TEG” and expanded by or filled with the specific properties and possibly facets of this TEG type. This class “TEG_x” is then ultimately instantiated in the associated engineering system in an installation project when a TEG of this type is placed in the installation project, and is optionally parameterised (for example with location codes, installation codes, necessary reliability). The relations between the instances or objects are implemented by pointers between the objects or by references to clear identities.

Framework formats and specific formats can be used for data deposition of the objects and relations or for data exchange. A framework format is an integration basis for different domains and disciplines and is suitable for the integration of specific formats. A specific format includes information and relationships of a specific domain or discipline. For example, the following may be used as a data format for a framework format: PLM XML, AutomationML, CAEX, STEP, etc. For example, the following may be used as a data format for a specific format: JT, Collada, PLCopen XML, STEP AP214, AP210, eClass, ProList.

FIG. 5 shows an exemplary device ES (for example engineering system) for carrying out the method according to certain embodiments. The method may be carried out by software (e.g., C, C++, Java, etc.) and may be implemented by a computer program product which prompts the execution of the method on a program-controlled device C. The software may also be stored on a computer-readable medium (for example floppy disk, CD, Smart media card, USB stick) containing instructions which, when they are run on a suitable computer C, prompt the computer C to implement the method.

The device ES may include a screen M for the graphical presentation of the mechatronic objects or of the installation model, input means EA (for example mouse, keyboard, touch-pen) for selecting and manipulating the objects, storage means DB for archiving created objects and models, as well as a processing unit C. The processing unit C may be a commercially available computer (for example a laptop, PC), or a robust industrial PC which is also suitable for applications in the shop floor area (for example in the factory building). In principle, the method can also be implemented by distributed computer architectures however (clusters, cloud computing) or in a web-based manner.

The engineering system ES may include the above-mentioned restrictions (material incompatibility, geometry, temporal behaviour, standards and guidelines, maintainability, etc.) in the calculations and can thus already automatically rule out some of the locations for installation of a thermoelectric generator which initially appeared to be suitable. The extent to which these criteria are already automatically considered may depend on the design of the engineering system ES, for by example parameterisation or configuration by an operator. Parameterisation could be carried out in a domain-specific manner for example.

The ultimate decision regarding the installation of a thermoelectric generator is normally made by the design engineer, to whom an indication of the best-possible locations for installation for each thermoelectric generator is given (for example, when selecting a thermoelectric generator the best locations for installation are marked in green, and further possible locations for installation are marked “yellow”, etc., similarly to above).

However, an optimization strategy implemented in the engineering system ES which assesses the advantages and disadvantages of the use of a thermoelectric generator at the possible energy provider MOs on the basis of technical criteria, as mentioned above, and on the basis of expected lifecycle costs and which automatically creates a complete solution (which can then optionally be modified by a design engineer) is also possible.

As an extension, the engineering system ES may additionally provide an option: if no, or only insufficient thermal energy is available for thermoelectric generators already scheduled/placed in the solution, this may be achieved by changing solution parameters, that is to say be feeding additional energy into the process so as to later utilise this energy at suitable points for thermoelectric generators. The engineering system ES then automatically calculates for this option the energy required along the MO energy producer chain, starting from the MO TEGs (thermoelectric generators which are modeled as mechatronic installation objects). This occurs form the perspective of the MO-TEGs as far as the energy sources and accumulates the energy required there (possibly incl. any energy losses in the MO chain). The engineering system ES is able to calculate a number of alternative possibilities and provides these alternatives to the design engineer for selection. The engineering system ES basically considers technical boundary conditions and rejects solutions which cannot be implemented (for example thermal limits in the process which may not be exceeded). Each new solution of the engineering system ES may additionally be assessed by the engineering system ES on the basis of economic criteria and information available in the mechatronic objects, and may be used by the design engineer as a basis for his decision (for example how high the increased energy costs are, owing to the additional energy feed). The engineering system ES may provide the design engineer with additional information regarding technical bottlenecks in the system, that is to say which mechatronic object prevents an increased energy feed owing to technical limitations. At the highest design stage, the engineering system ES may additionally suggest alternative mechatronic objects (MO) for these “bottleneck” MOs and may provide these to the design engineer for selection. The design engineer may then adopt an alternative solution or retain the original solution and accordingly make manual changes to his solution in the engineering system ES.

A depth and quality of information is thus implicitly reached by the engineering concept, which allows engineering of components with the complexity of thermoelectric generators at representative cost and for use with adequate reliability. For example, the observance of boundary conditions and the consistency of the resultant installation structure are thus directly ensured. Owing to the large amount of resultant information regarding relationships and links, the description of the installation structure is simultaneously significantly deepened, and therefore the detailing and optimisation of an installation energy balance for example is highly simplified. The design engineer thus has the option to adapt planning parameters, such as input power, in such a way that the use of thermoelectric generators is enabled.

The described extensions of an engineering system ES may be implemented within or as an additional module for a mechatronic engineering system, or else as a separate system.

In some embodiments, a method and system for placing thermoelectric generators in technical systems, wherein an installation model formed of interacting mechatronic objects, comprising type-specific and installation-specific thermodynamic prior and subsequent conditions, is created and, based on a respective thermal energy difference between the mechatronic objects, possible locations for use of thermoelectric generators in the installation are determined.

### LIST OF REFERENCE NUMERALS

A installation

TP sub-process

AG apparatus

EP energy potential

TEG thermoelectric generator

VB consumer

SE system property

UB ambient condition

MO1 to MO7 mechatronic object

ES engineering system

M monitor

C computer

DB database

V connection

EM input means

What is claimed is:

1. A method for placing thermoelectric generators in technical installations, comprising:
reproducing the technical installation as an installation model consisting of interacting mechatronic objects within the scope of installation engineering, wherein a mechatronic object contains type-specific thermodynamic prior and subsequent conditions;
supplementing the mechatronic objects with installation-specific thermodynamic conditions;
determining energy chains from installation engineering, wherein the energy chains consist of mechatronic objects connected in series;
determining the energy balance for each mechatronic object of the energy chain; and
examining the energy balance of the mechatronic objects of an energy chain upon fulfillment of necessary thermodynamic conditions for the use of thermoelectric generators.

2. The method of claim 1, further comprising:
automatically presenting locations for use with sufficient energy potential for thermoelectric generators in the installation model by suitable output means.

3. The method of claim 1, further comprising:
modeling the thermoelectric generator as a mechatronic object and integrating this mechatronic object in the installation model.

4. The method of claim 1, wherein when automatically presenting the locations for use of thermoelectric generators, at least one of the following conditions is considered: fail-safe operation of the energy source used, material incompatibility, installation topology, spatial conditions, temporal behaviour and/or standards and/or guidelines, maintainability, and physical properties of the thermoelectric generator.

5. The method of claim 3, further comprising:
calculating the energy available in the energy producer chain for the thermoelectric generator modeled as a mechatronic object; and
dedicated feeding of energy into the energy producer chain by energy sources modeled in the installation model if the-energy available for the thermoelectric generator modeled as a mechatronic object is insufficient.

6. A method for the localisation of thermoelectric generators in technical installations, comprising:
reproducing the technical installation as an installation model, consisting of interacting mechatronic objects, within the scope of installation engineering, wherein a mechatronic object contains type-specific thermodynamic prior and subsequent conditions;
supplementing the mechatronic objects with installation-specific thermodynamic conditions;
determining the respective thermal difference requirement for the mechatronic objects;
determining energy chains in the installation model;
modeling a thermoelectric generator as a mechatronic object, wherein the thermal difference requirement of the thermoelectric generator is deposited in the mechatronic object;
integrating the thermoelectric generator modeled as a mechatronic object in an energy chain of the installation model;
calculating the energy available in the energy chain for the thermoelectric generator modeled as a mechatronic object; and
dedicated feeding of energy into the energy chain by energy sources modeled in the installation model if the energy available for the thermoelectric generator modeled as a mechatronic object is insufficient.

7. The method of claim 6, wherein when integrating the thermoelectric generator modeled as a mechatronic object in the installation model, at least one of the following conditions is considered: fail-safe operation of the energy source used and/or material incompatibility, installation topology and/or spatial conditions, temporal behaviour, standards and/or guidelines, maintainability, physical properties of the thermoelectric generator.

8. The method of claim 6, wherein a mechatronic object represents a technical component of a technical installation and contains facets, wherein a discipline is assigned to a facet.

9. The method of claim 8, wherein at least one of the following disciplines can be assigned: mechanics, electrics, automation, distribution, calculation, project management, maintenance, safety, system management, civil engineering, and engineering.

10. A computer program product stored in non-transitory computer-readable media and executable by one or more processors to:
reproduce a technical installation as an installation model consisting of interacting mechatronic objects within the scope of installation engineering, wherein a mechatronic object contains type-specific thermodynamic prior and subsequent conditions;
supplement the mechatronic objects with installation-specific thermodynamic conditions;
determine energy chains from installation engineering, wherein the energy chains consist of mechatronic objects connected in series;
determine the energy balance for each mechatronic object of the energy chain; and
examine the energy balance of the mechatronic objects of an energy chain upon fulfillment of necessary thermodynamic conditions for the use of thermoelectric generators.

11-12. (canceled)

13. The computer program product of claim 10, further executable to automatically present locations for use with sufficient energy potential for thermoelectric generators in the installation model by suitable output means.

14. The computer program product of claim 10, further executable to model the thermoelectric generator as a mechatronic object and integrate this mechatronic object in the installation model.

15. The computer program product of claim 10, wherein when automatically presenting the locations for use of thermoelectric generators, at least one of the following conditions is considered: fail-safe operation of the energy source used, material incompatibility, installation topology, spatial conditions, temporal behaviour and/or standards and/or guidelines, maintainability, and physical properties of the thermoelectric generator.

16. The computer program product of claim 10, further executable to:
calculate the energy available in the energy producer chain for the thermoelectric generator modeled as a mechatronic object; and
cause dedicated feeding of energy into the energy producer chain by energy sources modeled in the installation model if the energy available for the thermoelectric generator modeled as a mechatronic object is insufficient.

17. The computer program product of claim 10, wherein a mechatronic object represents a technical component of a technical installation and contains facets, wherein a discipline is assigned to a facet.
